(19) United States
(12) Patent Application Publication
(10) Pub. No.: US 2024/0303042 A1
(43) Pub. Date: Sep. 12, 2024

(54) RANDOM NUMBER GENERATOR, RANDOM NUMBER GENERATION METHOD, AND NON-TRANSITORY COMPUTER READABLE MEDIUM STORING PROGRAM

(71) Applicants: NEC Corporation, Minato-ku, Tokyo (JP); NEC Solution Innovators, Ltd., Koto-ku, Tokyo (JP)

(72) Inventors: Nobutatsu Nakamura, Tokyo (JP); Shinji Hashimoto, Tokyo (JP); Reo Takahara, Tokyo (JP); Sho Shibata, Tokyo (JP); Hidenori Mori, Tokyo (JP)

(73) Assignees: NEC Corporation, Minato-ku, Tokyo (JP); NEC Solution Innovators, Ltd., Koto-ku, Tokyo (JP)

(21) Appl. No.: 18/272,744

(22) PCT Filed: Nov. 22, 2021
(86) PCT No.: PCT/JP2021/042759

§ 371 Date: Jul. 17, 2023

(30) Foreign Application Priority Data
Jan. 22, 2021 (JP) 2021-008663

(51) Int. Cl. G06F 7/58

(52) U.S. Cl. CPC G06F 7/588

(57) ABSTRACT

A random number generator includes an input receiving unit configured to receive an input for designating a probability distribution of random numbers, a model generation unit configured to generate, based on the probability distribution, an Ising model using n binary variables (n is an integer equal to or greater than 2) each of which is assigned to a respective one of n subintervals obtained by dividing a numerical range of random numbers, an annealing result acquisition unit configured to acquire values of the n binary variables, the values being an execution result of quantum annealing for the Ising model, and a random number output unit configured to output, as a random number, a value included in the subinterval assigned to the binary variable whose value, which has been obtained as the execution result, is equal to a predetermined value.

### TECHNICAL FIELD

The present invention relates to a random number generator, a random number generation method, and a program.

### BACKGROUND ART

For secure data communication and the like, it is important to obtain high-quality random numbers. However, in ordinary computers, random numbers obtained by function calls have a periodic characteristic. Further, random numbers generated by a random number generator using physical noises can be predicted by observing and reproducing physical phenomena. Therefore, these random numbers do not guarantee high security.

In recent years, the use of quantum computers has become widespread, and it has become possible for ordinary users to access and use such quantum computers through the Internet. Although the technology of quantum computers is still in a developing state, a type of quantum computers called a quantum annealing type (hereafter also referred to as quantum annealing machines) have already become available. Quantum annealing machines are computers specialized for solving a formulated problem called an Ising model, and are used for solving a combinatorial optimization problem or the like (see Patent Literature 1).

A combination of qubits (0, 1) in a stable state in a system represented by an Ising model can be obtained by a quantum annealing machine. However, because of a characteristic called quantum fluctuations, the same combination of qubits is not necessarily always obtained, and instead various combinations of qubits in a near-stable state are obtained. In principle, the occurrence probabilities of various combinations of qubits conform to (i.e., follow) a Boltzmann distribution. Therefore, in the case where a quantum annealing machine is used, it is possible to obtain a solution close to the optimal solution of the optimization problem, but it is not possible to obtain a solution (a numerical value) that conforms to (i.e., follow) a user-designated arbitrary distribution other than the Boltzmann distribution. Therefore, it has not been possible to use a quantum annealing machine to generate random numbers that conform to (i.e., follow) a user-designated arbitrary distribution.

Meanwhile, Patent Literature 2 discloses a technology for obtaining random numbers that conform to (i.e., follow) a user-designated distribution. In the technology disclosed in this literature, random numbers that conform to (i.e., follow) a predetermined distribution are obtained by performing predetermined processing on numerical values generated by a pseudo-random number generator. Since pseudo-random numbers have a periodic characteristic, random numbers obtained by this technology are not high-quality random numbers.

### CITATION LIST

### Patent Literature

Patent Literature 1: Published Japanese Translation of PCT International Publication for Patent Application, No. 2008-525873
Patent Literature 2: Japanese Unexamined Patent Application Publication No. 2019-79523

### SUMMARY OF INVENTION

### Technical Problem

As described above, there is a need for providing a technology for generating high-quality random numbers that conform to (i.e., follow) a desired distribution.

Therefore, an object that an example embodiment disclosed in this specification seeks to achieve is to provide a random number generator, a random number generation method, and a program capable of generating high-quality random numbers that conform to (i.e., follow) a desired distribution.

### Solution to Problem

A random number generator according to a first aspect of the present disclosure includes:
an input receiving unit configured to receive an input for designating a probability distribution of random numbers;
a model generation unit configured to generate, based on the probability distribution, an Ising model using n binary variables (n is an integer equal to or greater than 2) each of which is assigned to a respective one of n subintervals obtained by dividing a numerical range of random numbers;
an annealing result acquisition unit configured to acquire values of the n binary variables, the values being an execution result of quantum annealing for the Ising model; and
a random number output unit configured to output, as a random number, a value included in the subinterval assigned to the binary variable whose value, which has been obtained as the execution result, is equal to a predetermined value.

A method for generating a random number according to a second aspect of the present disclosure includes:
receiving, by a random number generator, an input for designating a probability distribution of random numbers;
generating, by the random number generator and based on the probability distribution, an Ising model using n binary variables (n is an integer equal to or greater than 2) each of which is assigned to a respective one of n subintervals obtained by dividing a numerical range of random numbers;
acquiring, by the random number generator, values of the n binary variables, the values being an execution result of quantum annealing for the Ising model; and
outputting, by the random number generator and as a random number, a value included in the subinterval assigned to the binary variable whose value, which has been obtained as the execution result, is equal to a predetermined value.

A program according to a third aspect of the present disclosure causes a computer to preform:
an input receiving step of receiving an input for designating a probability distribution of random numbers;
a model generation step of generating, based on the probability distribution, an Ising model using n binary variables (n is an integer equal to or greater than 2) each of which is assigned to a respective one of n subintervals obtained by dividing a numerical range of random numbers;
an annealing result acquisition step of acquiring values of the n binary variables, the values being an execution result of quantum annealing for the Ising model; and
a random number output step of outputting, as a random number, a value included in the subinterval assigned to the binary variable whose value, which has been obtained as the execution result, is equal to a predetermined value.

### Advantageous Effects of Invention

According to the above-described aspect, it is possible to provide a random number generator, a random number generation method, and a program capable of generating high-quality random numbers that conform to (i.e., follow) a desired distribution.

### BRIEF DESCRIPTION OF DRAWINGS

FIG. 1 is a block diagram showing an example of a configuration of a random number generator according to an outline of an example embodiment;

FIG. 2 is a block diagram showing an example of a configuration of a random number generation system according to a first example embodiment;

FIG. 3 is a block diagram showing an example of a hardware configuration of a random number generator according to the first example embodiment;

FIG. 4 is a flowchart showing an example of operations performed by the random number generator according to the first example embodiment;

FIG. 5 is a block diagram showing an example of a configuration of a random number generation system according to a second example embodiment;

FIG. 6 is a flowchart showing an example of operations performed by a random number generator according to the second example embodiment;

FIG. 7 is a block diagram showing an example of a configuration of a random number generation system according to a third example embodiment; and

FIG. 8 is a flowchart showing an example of operations performed by a random number generator according to the third example embodiment.

### EXAMPLE EMBODIMENT

### <Outline of Example Embodiment>

Prior to describing details of an example embodiment, firstly, an outline of the example embodiment will be described.

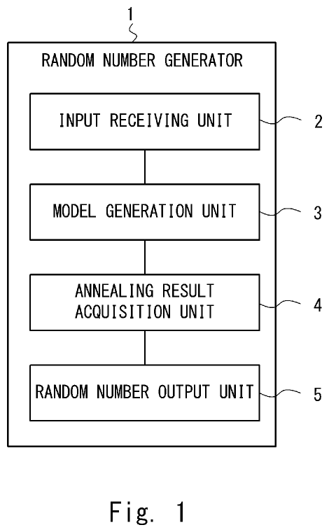

FIG. 1 is a block diagram showing an example of a configuration of a random number generator 1 according to an outline of an example embodiment. The random number generator 1 is an apparatus that generates random numbers by using a result of quantum annealing, and includes an input receiving unit 2, a model generation unit 3, an annealing result acquisition unit 4, and a random number output unit 5 as shown in FIG. 1.

The input receiving unit 2 receives an input for designating a probability distribution of random numbers. A user or the like provides (i.e., enters) an input for designating a desired probability distribution to the random number generator 1 in order to make the random number generator 1 output random numbers that conform to (i.e., follow) the desired probability distribution.

The model generation unit 3 generates, based on the probability distribution received by the input receiving unit 2, an Ising model using n binary variables (n is an integer equal to or greater than 2) each of which is assigned to a respective one of n subintervals obtained by dividing a numerical range of random numbers. Note that the numerical range of random numbers refers to a range that is determined by minimum and maximum values of random numbers that can be generated by the model generation unit 3. That is, the random number generator 1 generates random numbers belonging to this numerical range. Further, the value of the above-described binary variable indicates whether or not a subinterval belonging to this numerical range should be selected. In other words, this binary variable indicates whether or not a value included in the subinterval to which the binary variable is assigned should be adopted as a random number.

The annealing result acquisition unit 4 acquires values of n binary variables, which are an execution result of quantum annealing for the Ising model generated by the model generation unit 3. That is, the annealing result acquisition unit 4 makes a quantum annealing machine perform quantum annealing for the Ising model generated by the model generation unit 3, and acquires the execution result from the quantum annealing machine.

The random number output unit 5 outputs, as a random number, a value included in the subinterval assigned to the binary variable whose value, which has been obtained as the execution result, is equal to a predetermined value (e.g., 1).

As described above, the random number generator 1 generates an Ising model based on a designated probability distribution and outputs a random number according to the result of quantum annealing for this Ising model. Since it is difficult to predict the execution result of quantum annealing, it is also difficult to predict the random number output from the random number generator 1. Therefore, according to the random number generator 1, it is possible to generate high-quality random numbers that conform to (i.e., follow) a desired distribution.

### First Example Embodiment

Next, a first example embodiment will be described.

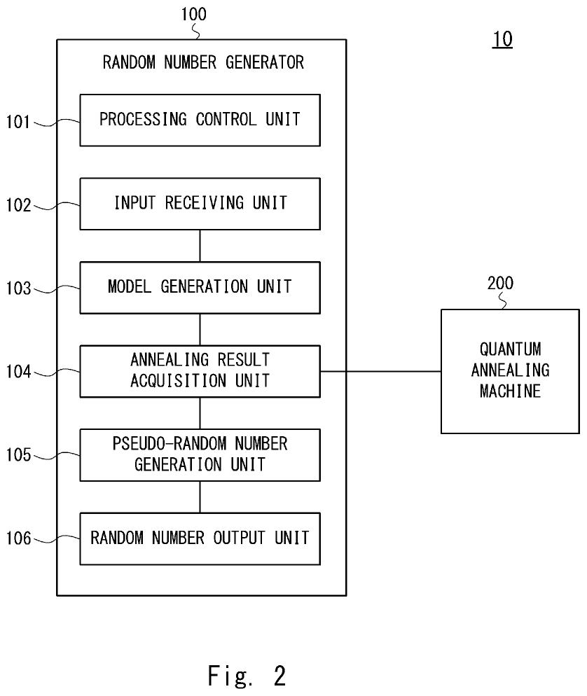

FIG. 2 is a block diagram showing an example of a configuration of a random number generation system 10 according to the first example embodiment. As shown in FIG. 2, the random number generation system 10 includes a random number generator 100 and a quantum annealing machine 200. The random number generator 100 and the quantum annealing machine 200 are connected to each other, for example, through a wired or wireless network so that they can communicate with each other. Note that in the configuration shown in FIG. 2, the quantum annealing machine 200 is shown as an apparatus separate from the random number generator 100, but it may be included in the random number generator 100.

The random number generator 100 corresponds to the random number generator 1 shown in FIG. 1. The quantum annealing machine 200 includes a quantum chip that realizes qubits and coupling between the qubits, and determines the value of each of the qubits by performing quantum annealing for an Ising model. Note that the quantum chip is a chip that operates by using a quantum state in quantum mechanics. Note that a well-known machine can be used as the quantum annealing machine 200 of the random number generation system 10, and therefore detailed descriptions of its specific configuration and processing are omitted.

A specific configuration and processing of the random number generator 100 will be described hereinafter.

As shown in FIG. 2, the random number generator 100 includes a processing control unit 101, an input receiving unit 102, a model generation unit 103, an annealing result acquisition unit 104, a pseudo-random number generation unit 105, and a random number output unit 106.

The processing control unit 101 controls processing performed by the aforementioned components of the random number generator 100. In this example embodiment, the processing control unit 101 controls, in particular, the number of times of processing performed by the annealing result acquisition unit 104 and the pseudo-random number generation unit 105 according to the number of random numbers to be generated.

The input receiving unit 102 corresponds to the input receiving unit 2 shown in FIG. 1 and receives an input for designating a probability distribution of random numbers. The input receiving unit 102 may receive, for example, a probability distribution entered by a user through an input interface provided in the random number generator 100 or by reading the probability distribution from a storage device, such as a memory, provided in the random number generator 100. Alternatively, the input receiving unit 102 may receive a probability distribution transmitted from other apparatuses.

In this example embodiment, the input receiving unit 102 receives, as an input for designating a probability distribution of random numbers, a set value of a probability for each subinterval. This subinterval is one that is obtained by dividing a domain of definition of a random variable into a plurality of sections, and can be considered to one that is obtained by dividing a numerical range of random numbers. For example, let R_{MIN} and R_{MAX} stand for minimum and maximum values, respectively, of random numbers that are desired to be generated by the random number generator 100. That is, the following description will be given by using an example case where random numbers no smaller than R_{MIN} and no greater than R_{MAX} are generated by the random number generator 100. In this case, the random number generator 100 receives n set values (n is an integer equal to or greater than 2) each of which is a set value of a probability for each subinterval that is obtained by equally dividing the numerical range from R_{MIN}, which is the lower limit, to R_{MAX}, which is the upper limit, into n sections. That is, the input receiving unit 102 receives a designation of a probability pᵢ for each subinterval. Note that the subscript i is an identification number of a subinterval, and is an integer no smaller than 1 and no greater than n. For example, when it is desired to make a numerical value belonging to a certain subinterval most likely to be output as a random number, the value of the probability pᵢ of that subinterval is set to a value that is greater than any of the values of the probabilities pᵢ of the other subintervals. Note that the sum total of p₁ to pₙ is 1.

The value of each of n, R_{MIN}, and R_{MAX} described above may be determined in advance or may be received by the input receiving unit 102. As described above, it is possible to improve the usability of the random number generator 100 in its operation by enabling a user or the like to designate the values of n, R_{MIN}, and R_{MAX}, too.

Note that although the input receiving unit 102 receives a set value of a probability for each subinterval in this example embodiment, the input for designating the probability distribution is not limited to this example. For example, the input receiving unit 102 may receive, as an input for designating a probability distribution of random numbers, information designating a type of probability distribution (e.g., a normal distribution or the like) and parameters of a distribution (such as a mean and a variance), or receive a mathematical expression representing a probability distribution.

Note that the input receiving unit 102 may also receive the designation for the number of random numbers to be generated.

The model generation unit 103 corresponds to the model generation unit 3 shown in FIG. 1 and generates, based on the probability distribution received by the input receiving unit 102, an Ising model using n binary variables (qubit variables) each of which is assigned to a respective one of n subintervals. In this example, n binary variables (qubit variables) are represented by x₁, x₂, . . . and xₙ. That is, a binary variable xᵢ is assigned to an ith subinterval. Therefore, an ith subinterval is associated with a probability pᵢ and a binary variable xᵢ.

Specifically, the model generation unit 103 generates, for example, a model H(x) represented by the below-shown Expression 1:

$$H ( x ) = {\sum }_{i = 1}^{n} - ( log ( {p}_{i} ) ) {x}_{i} + {H}_{Onehot} \qquad < Expression 1 >$$

Note that i is a number for identifying each of n subinterval as described above. A binary variable xᵢ is a binary variable assigned to an ith subinterval and has a value of 0 or 1. A probability pᵢ is a value of a probability distribution in a subinterval to which xᵢ is assigned.

In Expression 1, a function represented by the first term on the right side (also referred to as a first function) is an objective function. An approximate solution (i.e., a combination of values of binary variables x₁, x₂, . . . and xₙ) that satisfies a constraint represented by a function H_{Onehot} (also referred to as a second function) and minimizes the value of the aforementioned objective function is searched for by the quantum annealing machine 200. Further, the function H_{Onehot} represented by the second term on the right side is such a constraint that one of the n binary variables x₁, x₂, . . . and xₙ has a predetermined value (e.g., 1) and each of the other binary variables has a value other than the predetermined value (e.g., 0). Specifically, the function H_{Onehot} is represented by the below-shown Expression 2. Note that w is a coefficient representing a weight, and the model generation unit 103 sets a predetermined positive value as the value of w.

$${H}_{Onehot} = {w ( {\sum }_{i = 1}^{n} {x}_{i} - 1 )}^{2} \qquad < Expression 2 >$$

The model generation unit 103 determines the value of pᵢ of the model represented by the above-shown Expression according to the designation of the probability distribution of random numbers received by the input receiving unit 102, and thereby generates an Ising model for generating random numbers that conform to (i.e., follow) this probability distribution. Note that when the input receiving unit 102 receives a mathematical expression representing a probability distribution, or receives a type and parameters of a probability distribution instead of receiving the set value of the probability pᵢ for each subinterval, the model generation unit 103 generates the above-described Ising model as follows. In this case, the model generation unit 103 generates the above-described Ising model by specifying a probability pᵢ for each subinterval by using n, R_{MIN}, and R_{MAX}. In this case, when the value of a probability distribution in a subinterval is not constant, the model generation unit 103 may determine a probability pᵢ by using, for example, a mean value, a minimum value, a maximum value or the like of the value of the probability distribution in this subinterval.

As can be seen from the above-shown Expression, it can be considered that the model generation unit 103 generates the following Ising Model. The model generation unit 103 generates an Ising Model that is expressed by using a first function for the binary variable xᵢ and a second function for the binary variable xᵢ. Note that the first function is a function that is expressed by the sum total of products of the value of a function whose value decreases as the value pᵢ of the probability distribution in the subinterval to which the binary variable xᵢ is assigned increases and the value of this binary variable xᵢ. Further, the second function is a function that has the minimum value when one of the n binary variables x₁, x₂, . . . and xₙ has a predetermined value, and when this condition is not satisfied, has a positive value depending on a weight w.

The annealing result acquisition unit 104 corresponds to the annealing result acquisition unit 4 shown in FIG. 1 and acquires the value of each of the n binary variables x₁, x₂, . . . and xₙ, which are the execution result of quantum annealing for the Ising model generated by the model generation unit 103. In order to make the quantum annealing machine 200 perform processing, the annealing result acquisition unit 104 sets, based on the Ising model generated by the model generation unit 103, conditions for quantum annealing performed by the quantum annealing machine 200. Specifically, the annealing result acquisition unit 104 sets, based on the Ising model generated by the model generation unit 103, qubits corresponding to the binary variables and the strengths of interactions between the qubits. Then, the annealing result acquisition unit 104 instructs the quantum annealing machine 200 to perform the quantum annealing for the Ising model.

In response to this, the quantum annealing machine 200 outputs the execution result of the quantum annealing, i.e., the value of each of the n binary variables x₁, x₂, . . . and xₙ, to the random number generator 100, and the annealing result acquisition unit 104 acquires this execution result. The quantum annealing machine 200 outputs, as the execution result of the quantum annealing, an approximate solution that minimizes H(x) represented by Expression 1. Specifically, the annealing result acquisition unit 104 acquires the following execution result as the execution result of the quantum annealing for the Ising model represented by Expression 1. That is, the annealing result acquisition unit 104 acquires the execution result in which one of the n binary variables x₁, x₂, . . . and xₙ has a predetermined value (e.g., 1) and each of the other binary variables has a value other than the predetermined value (e.g., 0).

Note that a probability that the value of a binary variable xᵢ becomes 1 is represented by pᵢ. Therefore, the random number generator 100 can generate a random number that conforms to (i.e., follow) the designated probability distribution by outputting, as the random number, a value belonging to the subinterval corresponding to the binary variable xᵢ whose value is equal to the predetermined value (e.g., 1). The random number generator 100 may output, as a random number, a predetermined value within the subinterval corresponding to the binary variable xᵢ whose value is equal to the predetermined value, but in this example embodiment, the random number generator 100 includes the pseudo-random number generation unit 105 so that it can output more various values as a random number. Note that the predetermined value within a subinterval is, for example, a median value, a maximum value, a minimum value or the like of this subinterval.

The pseudo-random number generation unit 105 generates a pseudo-random number (a uniform random number) within the subinterval assigned to the binary variable xi whose value, which has been obtained as the execution result of quantum annealing, is equal to a predetermined value (e.g., 1). That is, the pseudo-random number generation unit 105 generates a pseudo-random number for which the minimum value in the subinterval is the minimum value of the pseudo-random number and the maximum value in the subinterval is the maximum value of the pseudo-random number. The pseudo-random number generation unit 105 generates a pseudo-random number by using a well-known function for generating a pseudo-random number. For example, the pseudo-random number generation unit 105 may obtain a pseudo-random number by calling an intrinsic function that returns a random value.

The random number output unit 106 corresponds to the random number output unit 5 shown in FIG. 1 and outputs, as a random number, a value included in the subinterval that has been selected according to the execution result of the quantum annealing. In this example embodiment, the random number output unit 106 outputs, as a value included in the selected subinterval, a pseudo-random number generated by the pseudo-random number generation unit 105. Note that although the random number output unit 106 outputs a pseudo-random number in the selected subinterval according to the execution result of the quantum annealing in this example embodiment, the random number output unit 106 may output a predetermined value within the subinterval as described above. In this case, the random number generator 100 does not necessarily have to include the pseudo-random number generation unit 105. The random number output unit 106 outputs a random number to an arbitrary output destination. For example, the random number output unit 106 may output a random number to a display, or may transmit a random number to an apparatus or a processing unit that performs predetermined processing such as encryption processing.

The random number generator 100 may generate a plurality of random numbers, and in such a case, the random number output unit 106 outputs the plurality of generated random numbers. The processing control unit 101 controls the number of times of processing performed by the annealing result acquisition unit 104 and the pseudo-random number generation unit 105 according to the number of random numbers to be generated. As described above, one random number can be generated every time quantum annealing is performed for the Ising model represented by Expression 1. Therefore, for example, when m random numbers (m is a positive integer) are to be generated, the processing control unit 101 performs control so as to repeat the processing performed by the annealing result acquisition unit 104 and the pseudo-random number generation unit 105 m times. Note that the value of m may be determined in advance or may be received by the input receiving unit 102. As described above, the random number generator 100 outputs a plurality of random numbers by acquiring execution results of quantum annealing processes that have been performed for the same Ising model a plurality of times. In this way, it is possible to obtain an arbitrary number of random numbers.

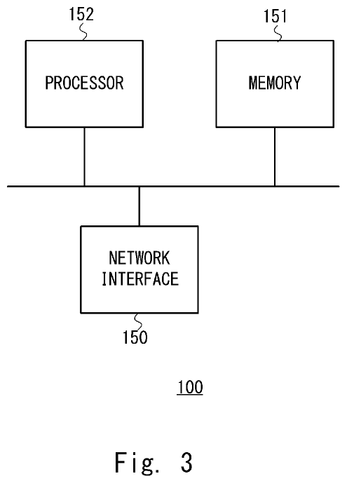

FIG. 3 is a block diagram showing an example of a hardware configuration of the random number generator 100. As shown in FIG. 3, the random number generator 100 includes a network interface 150, a memory 151, and a processor 152. The network interface 150, the memory 151, and the processor 152 are connected to each other through a data bus or the like.

The network interface 150 is used to communicate with other arbitrary apparatuses including the quantum annealing machine 200. The network interface 150 may include, for example, a network interface card (NIC).

The memory 151 is composed of, for example, a combination of a volatile memory and a nonvolatile memory. The memory 151 is used to store software (a computer program(s)) including at least one instruction, which is executed by the processor 152, and data and the like used for various types of processing performed by the random number generator 100.

The processor 152 performs processing of each component shown in FIG. 2 by loading the software (the computer program(s)) from the memory 151 and executing the loaded software.

The processor 152 may be a microprocessor, an MPU (Micro Processor Unit), or a CPU (Central Processing Unit). The processor 152 may include a plurality of processors.

As descried above, the random number generator 100 is an apparatus that functions as a computer and is also referred to as an information processing apparatus.

Note that the aforementioned program may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), CD-R, CD-R/W, and a semiconductor memory (such as a mask ROM, a PROM (Programmable ROM), an EPROM (Erasable PROM), a flash ROM, and a RAM (Random Access Memory). Further, the programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

Next, a flow of operations performed by the random number generator 100 will be described.

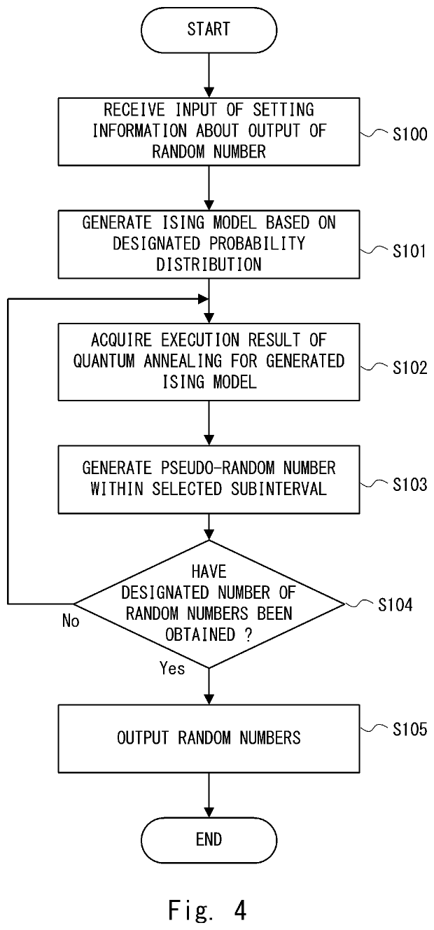

FIG. 4 is a flowchart showing an example of operations performed by the random number generator 100. Operations for generating random numbers performed by the random number generator 100 will be described hereinafter with reference to FIG. 4.

In a step S100, the input receiving unit 102 receives an input of setting information about an output of random numbers. Specifically, the input receiving unit 102 receives an input for designating a probability distribution of random numbers. Further, as described above, the input receiving unit 102 may also receive an input for designating one or all of the number n of divisions, a minimum value R_{MIN} of random numbers, a maximum value R_{MAX} thereof, and the number m of random numbers to be generated.

Next, in a step S101, the model generation unit 103 generates an Ising model based on the probability distribution designated in the step S100.

Next, in a step S102, the annealing result acquisition unit 104 acquires, from the quantum annealing machine 200, an execution result of quantum annealing for the Ising model generated in the step S101. That is, the annealing result acquisition unit 104 acquires the value of each of n binary variables x₁, x₂, . . . and xₙ.

Next, in a step S103, the pseudo-random number generation unit 105 generates a pseudo-random number within a subinterval that is selected based on the execution result acquired in the step S102. That is, the pseudo-random number generation unit 105 generates a pseudo-random number that is contained in the subinterval corresponding to xᵢ having a value of 1.

Next, in a step S104, the processing control unit 101 determines whether or not the designated number of random numbers have been obtained. When the designated number of random numbers have not been obtained yet, the processing control unit 101 performs control so as to perform the processing in the steps S102 and S103 again. On the other hand, when the designated number of random numbers have already been obtained, the process proceeds to a step S105.

In the step S105, the random number output unit 106 outputs the random numbers obtained by the processing in the steps S102 and S103.

The first example embodiment has been described above. In this example embodiment, a subinterval is selected based on the result of quantum annealing. Therefore, it is difficult to predict which subinterval is selected. Further, for each subinterval, a probability that the subinterval is selected conforms to (i.e., follow) the designated probability distribution. Therefore, according to this example embodiment, it is possible to generate high-quality random numbers that conform to (i.e., follow) a desired distribution.

### Second Example Embodiment

Next, a second example embodiment will be described.

Let k (k is an integer equal to or greater than 2) stand for the number of qubits provided in the quantum annealing machine 200. In this case, in the random number generator 100 shown in the first example embodiment, the selection of a subinterval using a quantum characteristic, i.e., the selection of a subinterval of which the prediction is difficult, is made from k subintervals even at the maximum. That is, the number of subintervals that can be set depends on the number of qubits. In this example embodiment, subintervals are repeatedly selected in a hierarchical manner, so that they are selected from among a larger number of subintervals. In this way, even when the number of qubits of the quantum annealing machine 200 is limited, a random number that is selected from among a larger number of subintervals can be output.

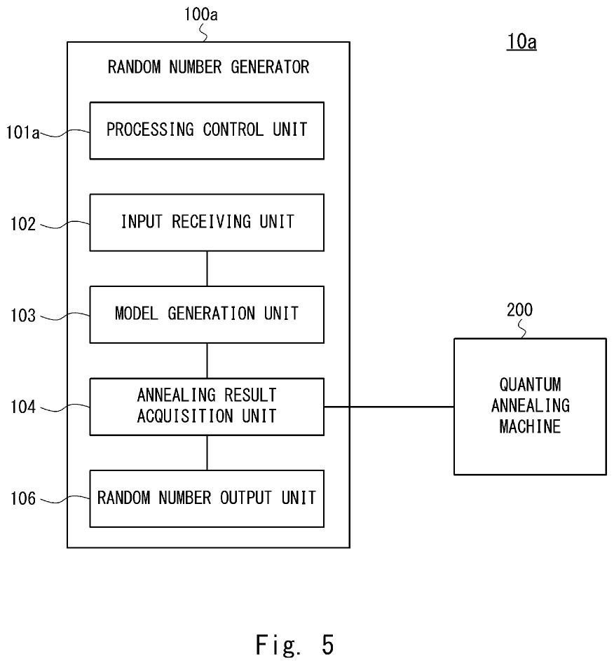

FIG. 5 is a block diagram showing an example of a configuration of a random number generation system 10a according to the second example embodiment. As shown in FIG. 5, the random number generation system 10a according to the second example embodiment differs from the random number generation system 10 according to the first example embodiment in that the random number generator 100 is replaced by a random number generator 100a.

Parts of the configuration and processing of the second example embodiment different from those of the first example embodiment will be described hereinafter, and descriptions of parts of the configuration and processing thereof similar to those of the first example embodiment will be omitted as appropriate.

As shown in FIG. 5, the random number generator 100a according to the second example embodiment differs from the random number generator 100 according to the first example embodiment mainly in that the processing control unit 101 is replaced by a processing control unit 101a. Further, the pseudo-random number generation unit 105 is omitted in the configuration example shown in FIG. 5. However, in this example embodiment, the random number generator 100a may include the pseudo-random number generation unit 105. That is, when a numerical value included in a subinterval that is eventually selected in this example embodiment is output as a random number, a random number generated by the pseudo-random number generation unit 105, instead of a predetermined value included in the subinterval, may be output.

Note that although the quantum annealing machine 200 is also shown as an apparatus separate from the random number generator 100a in the configuration shown in FIG. 5, the quantum annealing machine 200 may be included in the random number generator 100a.

Similarly to the processing control unit 101, the processing control unit 101a controls processing of each component of the random number generator 100a shown in FIG. 5. In particular, the processing control unit 101a controls the processing of the model generation unit 103 and the annealing result acquisition unit 104 so as to select a subinterval a predetermined number of times in a hierarchical manner. Note that the hierarchical selection of subintervals means to select a subinterval from among n subintervals according to the result of quantum annealing, and then to further select, according to the result of further quantum annealing, a subinterval from among n smaller subintervals that are set in the selected subinterval. The processing control unit 101a controls so as to repeat the hierarchical selection of a subinterval by quantum annealing q times (q is an integer). Note that when q is zero (q=0), random numbers are output without performing the hierarchical selection of subintervals, i.e., without performing the re-selection of subintervals, as in the case of the first example embodiment. Note that the value of q may be determined in advance or may be received by the input receiving unit 102.

In order to perform the hierarchical selection of subintervals, the model generation unit 103 according to this example embodiment performs the following processing under the control by the processing control unit 101a. After generating the model, the model generation unit 103 also generates, based on the designated probability distribution, a new Ising model using n binary variables each of which is assigned to a respective one of n new subintervals that have been obtained by further dividing the subinterval selected by the execution of quantum annealing. Specifically, the model generation unit 103 newly generates an Ising model represented by Expression 1 in order to perform the hierarchical selection of subintervals. However, in the new Ising model, the n binary variables xᵢ are variables each of which is assigned to a respective one of the n new subintervals that have been obtained by further dividing the selected subinterval. Further, a probability pᵢ is a value of a probability distribution in a new subinterval.

For example, when the input receiving unit 102 receives a mathematical expression representing a probability distribution, or receives a type and parameters of a probability distribution, the model generation unit 103 specifies a probability pᵢ for a new subinterval by using the number n of divisions and the range of the selected subinterval. In this case, when the value of the probability distribution in the new subinterval is not constant, the model generation unit 103 may determine the probability pᵢ in the new subinterval by using, for example, a mean value, a minimum value, a maximum value or the like of the value of the probability distribution in this subinterval. Further, the input receiving unit 102 may receive an input for designating each of set values of probabilities pᵢ for the new subinterval. Note that when the sum total of probabilities pᵢ for the new subinterval is not 1, the model generation unit 103 normalizes the values of the probabilities pᵢ so that the sum total thereof becomes 1, and then generates a new Ising model based thereon.

In order to perform the hierarchical selection of subintervals, the annealing result acquisition unit 104 according to this example embodiment performs the following processing under the control by the processing control unit 101a. When the model generation unit 103 generates the above-described new Ising model, the annealing result acquisition unit 104 acquires the values of n binary variables which are the execution result of quantum annealing for this new Ising model. The acquired values of the n binary variables indicate which of the sub-divided subintervals should be selected.

When the hierarchical selection of subintervals is finished, the random number output unit 106 according to this example embodiment outputs, as a random number, a value included in the subinterval that has been eventually selected. That is, the random number output unit 106 outputs, as a random number, a value included in the new subinterval assigned to the binary variable xᵢ whose value, which has been obtained as the execution result of the quantum annealing for the new Ising model, is equal to a predetermined value (e.g., 1). Note that although the random number output unit 106 outputs a predetermined value in the selected subinterval (e.g., a median value, a maximum value, a minimum value or the like of the subinterval) as a random number in this example embodiment, the random number output unit 106 may output a value generated by the pseudo-random number generation unit 105.

Next, a flow of operations performed by the random number generator 100a will be described.

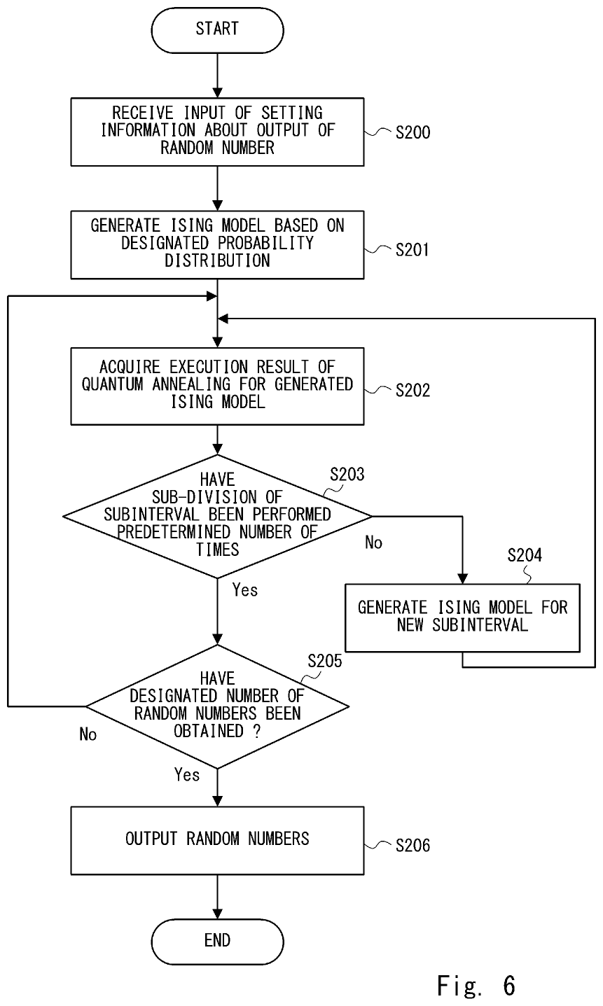

FIG. 6 is a flowchart showing an example of operations performed by the random number generator 100a. Operations for generating random numbers performed by the random number generator 100a will be described hereinafter with reference to FIG. 6.

In a step S200, similarly to the step S100 in FIG. 4, the input receiving unit 102 receives an input of setting information about an output of random numbers.

Next, in a step S201, similarly to the step S101 in FIG. 4, the model generation unit 103 generates an Ising model based on the probability distribution designated in the step S200.

Next, in a step S202, similarly to the step S102 in FIG. 4, the annealing result acquisition unit 104 acquires, from the quantum annealing machine 200, an execution result of quantum annealing for the Ising model generated in the step S201.

Next, in a step S203, the processing control unit 101a determines whether or not the sub-division of the subinterval has been performed a predetermined number of times. That is, the processing control unit 101a determines whether or not the hierarchical selection of a subinterval has been performed q times. When the sub-division of the subinterval has not been performed the predetermined number of times, the processing control unit 101a performs control so as to perform the generation of an Ising model and the execution of quantum annealing again. That is, in this case, the process proceeds to a step S204. On the other hand, when the sub-division of the subinterval has been performed the predetermined number of times, the process proceeds to a step S205.

In the step S204, the model generation unit 103 generates an Ising model for the new subinterval in order to perform the hierarchical selection of a subinterval. That is, the model generation unit 103 generates an Ising model for n new subintervals that have been obtained by further dividing the subinterval assigned to the binary variable xᵢ whose value obtained as the execution result of quantum annealing in the step S202 is equal to the predetermined value. After the processing in the step S204, the process returns to the step S202, and the annealing result acquisition unit 104 acquires, from the quantum annealing machine 200, an execution result of quantum annealing for the Ising model generated in the step S204. After that, the determination process in the step S203 is performed again.

When the sub-division of the subinterval is performed the predetermined number of times, one random number is obtained. In the step S205, the processing control unit 101a determines whether or not the designated number of random numbers have been obtained. When the designated number of random numbers have not been obtained yet, the processing control unit 101a performs control so as to perform the processing in the steps S202 to S204 again. Note that in this case, in the step S202, the annealing result acquisition unit 104 acquires the execution result of quantum annealing for the Ising model using the binary variable xᵢ assigned to the initial subinterval that has not been sub-divided yet. That is, in the subsequent processing, the hierarchical selection of a subinterval is newly repeated. On the other hand, when the designated number of random numbers have already been obtained, the process proceeds to a step S206.

In a step S206, the random number output unit 106 outputs the random numbers that have been obtained by the processing in the steps S202 to S204.

The second example embodiment has been described above. In this example embodiment, subintervals are repeatedly selected in a hierarchical manner, so that they are selected from among a larger number of subintervals. In this way, even when the number of qubits of the quantum annealing machine 200 is limited, a random number that is selected from among a larger number of subintervals can be output.

### Third Example Embodiment

Next, a third example embodiment will be described. This example embodiment differs from the above-described example embodiment in that the quantum annealing machine 200 simultaneously performs quantum annealing on a plurality of Ising models for generating random numbers. When the quantum annealing machine 200 includes a sufficient number of qubits, the quantum annealing machine 200 can obtain solutions for a plurality of Ising models. Therefore, in this example embodiment, a random number generator 100b that can efficiently obtain a plurality of random numbers by performing quantum annealing only once for a plurality of Ising models will be described.

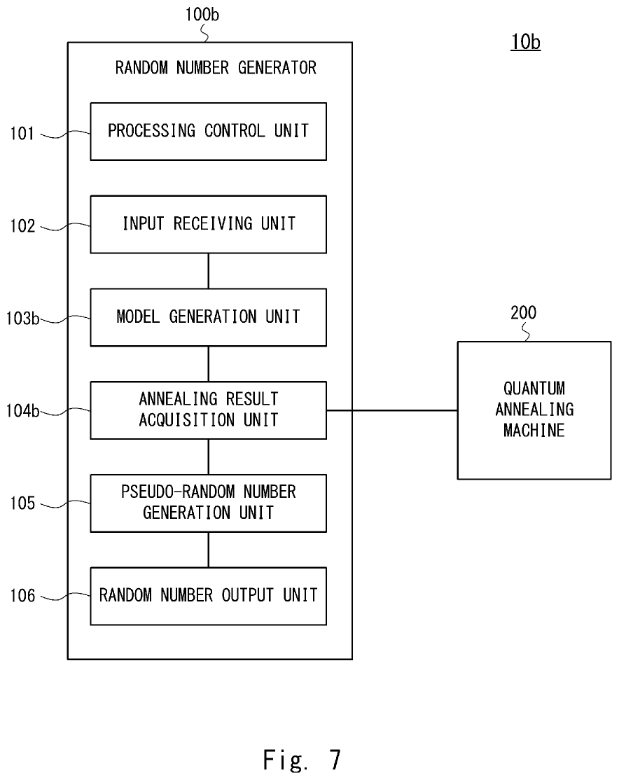

FIG. 7 is a block diagram showing an example of a configuration of a random number generation system 10b according to the third example embodiment. As shown in FIG. 7, the random number generation system 10b according to the third example embodiment differs from the random number generation system 10 according to the first example embodiment in that the random number generator 100 is replaced by a random number generator 100b. Note that although the random number generator 100b includes the pseudo-random number generation unit 105 in the configuration shown in FIG. 7, the pseudo-random number generation unit 105 may be omitted when the random number generator 100b outputs a predetermined value within a subinterval as a random number.

Parts of the configuration and processing of the third example embodiment different from those of the first example embodiment will be described hereinafter, and descriptions of parts of the configuration and processing thereof similar to those of the first example embodiment will be omitted as appropriate.

As shown in FIG. 7, the random number generator 100b according to the third example embodiment differs from the random number generator 100 according to the first example embodiment mainly in that the model generation unit 103 is replaced by a model generation unit 103b and the annealing result acquisition unit 104 is replaced by an annealing result acquisition unit 104b. Note that although the quantum annealing machine 200 is also shown as an apparatus separate from the random number generator 100b in the configuration shown in FIG. 7, the quantum annealing machine 200 may be included in the random number generator 100b.

Similarly to the model generation unit 103, the model generation unit 103b generates Ising models based on a probability distribution received by the input receiving unit 102. In this example embodiment, the model generation unit 103b generates the model H(x) represented by Expression 1. However, the model generation unit 103b generates a plurality of Ising models for which quantum annealing processes are simultaneously performed. In the following description, the number of Ising models for which quantum annealing processes are simultaneously performed is represented by s (s is an integer equal to or greater than 2). That is, the model generation unit 103b generates s Ising models. Note that the s Ising models may be the same as each other or different from each other. Therefore, each Ising model may have a different number of binary variables xᵢ (i.e., a different value of n), a different value of the probability value pᵢ (i.e., a different probability distribution), and/or different subintervals assigned to the binary variables xᵢ. For the sake of explanation, let t stand for the total number of binary variables xᵢ in the s Ising models. Note that when the numbers xᵢ of binary variables in each of the Ising models are represented as n₁, n₂, . . . and nₛ, they satisfy a relation t=n₁+n₂+ . . . +nₛ. Note that when n₁, n₂, . . . and nₛ are all integers equal to or greater than 2, t is an integer equal to or greater than 4 because s is an integer equal to or greater than 2.

Each of the t binary variables xᵢ in total in the s Ising models generated by the model generation unit 103b is associated with a different qubit. Therefore, when the number of qubits included in the quantum annealing machine 200 is k, the value of t is equal to or smaller than k.

The annealing result acquisition unit 104b associates the t binary variables xᵢ, which constitutes a set of binary variables xᵢ in the s Ising models, with t qubits, respectively, included in the same quantum annealing machine 200. The quantum annealing machine 200 simultaneously performs quantum annealing for the s Ising models and thereby obtains the solutions of the s Ising models. In this way, the annealing result acquisition unit 104b obtains the values of the t binary variables xᵢ which are the execution results of quantum annealing for the s Ising models.

Next, a flow of operations performed by the random number generator 100b will be described.

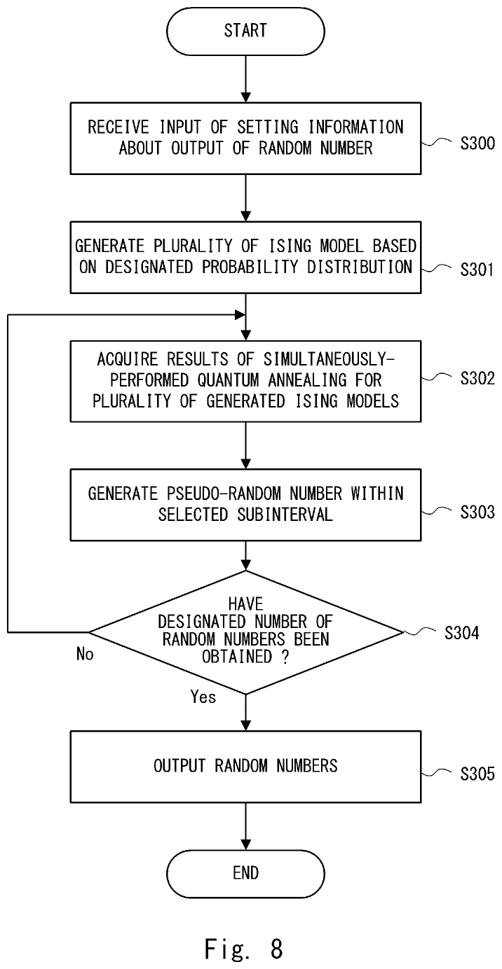

FIG. 8 is a flowchart showing an example of operations performed by the random number generator 100b. Operations for generating random numbers performed by the random number generator 100b will be described hereinafter with reference to FIG. 8.

In a step S300, similarly to the step S100 in FIG. 4, the input receiving unit 102 receives an input of setting information about an output of random numbers. In this step, the input receiving unit 102 receives information necessary to generate each of a plurality of Ising models.

Next, in a step S301, the model generation unit 103b generates the plurality of Ising models based on the probability distribution(s) designated in the step S300.

Next, in a step S302, the annealing result acquisition unit 104b acquires, from the quantum annealing machine 200, the results of simultaneously-performed quantum annealing processes for the plurality of Ising models generated in the step S301. That is, the annealing result acquisition unit 104b acquires the values of the binary variables xᵢ of each of the Ising models. In this way, it becomes possible to select a subinterval(s) in each of the Ising models.

Next, in a step S303, the pseudo-random number generation unit 105 generates pseudo-random numbers within subintervals that are selected based on the execution results acquired in the step S302. The pseudo-random number generation unit 105 generates a pseudo-random number for each of the generated Ising models.

Next, in a step S304, the processing control unit 101 determines whether or not the designated number of random numbers have been obtained. In this example embodiment, since quantum annealing processes are simultaneously performed for a plurality of Ising models, a plurality of random numbers can be obtained by performing the processing in the steps S302 and S303 only once. However, when the number of obtained random numbers still does not reach the designated number, quantum annealing processes are performed again. Therefore, when the designated number of random numbers have not been obtained yet, the processing control unit 101 performs control so as to perform the processing in the steps S302 and S303 again. On the other hand, when the designated number of random numbers have already been obtained, the process proceeds to a step S305.

In the step S305, the random number output unit 106 outputs the random numbers obtained by the processing in the steps S302 and S303.

The third example embodiment has been described above. In this example embodiment, random numbers are generated by using results of quantum annealing processes that are simultaneously performed for a plurality of Ising models. Therefore, it is possible to efficiently generate random numbers by using the quantum annealing machine 200.

Note that this example embodiment can be combined with the second example embodiment. That is, similarly to the second example embodiment, subintervals may also be repeatedly selected in a hierarchical manner in this example embodiment. In this case, the model generation unit 103b generates, for each of s existing Ising models, one new Ising model using binary variables assigned to new subintervals obtained by sub-dividing the subinterval. Then, the annealing result acquisition unit 104b acquires values of t binary variables which are the execution results of quantum annealing processes further performed for the s new Ising models.

Note that the present invention is not limited to the above-described example embodiments, and they can be modified as appropriate without departing from the scope and spirit of the invention. For example, an information processing apparatus including the above-described random number generator may include a processing unit that performs predetermined processing using generated random numbers. For example, the processing unit may perform a certain well-known encryption process using random numbers or perform a simulation process using random numbers such as a Monte Carlo simulation. Note that this processing unit may also be implemented by, for example, having a processor execute a program stored in a memory.

Note that although a random number is generated by using an execution result of quantum annealing for an Ising model in the above-described example embodiment, an execution result of simulated annealing may be used instead of the quantum annealing.

Although the present invention is described above with reference to example embodiments, the present invention is not limited to the above-described example embodiments. Various modifications that can be understood by those skilled in the art can be made to the configuration and details of the present invention within the scope of the invention.

This application is based upon and claims the benefit of priority from Japanese patent application No. 2021-008663, filed on Jan. 22, 2021, the disclosure of which is incorporated herein in its entirety by reference.

### REFERENCE SIGNS LIST

1 RANDOM NUMBER GENERATOR
2 INPUT RECEIVING UNIT
3 MODEL GENERATION UNIT
4 ANNEALING RESULT ACQUISITION UNIT
5 RANDOM NUMBER OUTPUT UNIT
10 RANDOM NUMBER GENERATION SYSTEM
10a RANDOM NUMBER GENERATION SYSTEM
10b RANDOM NUMBER GENERATION SYSTEM
100 RANDOM NUMBER GENERATOR
100a RANDOM NUMBER GENERATOR
100b RANDOM NUMBER GENERATOR
101 PROCESSING CONTROL UNIT
101a PROCESSING CONTROL UNIT
102 INPUT RECEIVING UNIT
103 MODEL GENERATION UNIT
103b MODEL GENERATION UNIT
104 ANNEALING RESULT ACQUISITION UNIT
104b ANNEALING RESULT ACQUISITION UNIT
105 PSEUDO-RANDOM NUMBER GENERATION UNIT
106 RANDOM NUMBER OUTPUT UNIT
150 NETWORK INTERFACE
151 MEMORY
152 PROCESSOR
200 QUANTUM ANNEALING MACHINE

What is claimed is:

1. A random number generator comprising:
at least one memory storing instructions; and
at least one processor configured to execute the instructions stored in the memory to:
receive an input for designating a probability distribution of random numbers;
generate, based on the probability distribution, an Ising model using n binary variables (n is an integer equal to or greater than 2) each of which is assigned to a respective one of n subintervals obtained by dividing a numerical range of random numbers;
acquire values of the n binary variables, the values being an execution result of quantum annealing for the Ising model; and
output, as a random number, a value included in the subinterval assigned to the binary variable whose value, which has been obtained as the execution result, is equal to a predetermined value.

2. The random number generator according to claim 1, wherein
the Ising model is a model expressed by using a first function of the binary variables and a second function of the binary variables,
the first function is expressed by a sum total of products of a value of a function and values of the binary variables, the function being such a function that its value becomes smaller as a value of the probability distribution in the subinterval to which the binary variable is assigned becomes larger, and
the second function is a function that has a minimum value when a value of one of the n binary variables is equal to the predetermined value.

3. The random number generator according to claim 1, wherein the processor is further configured to execute the instructions to:
further generate, based on the probability distribution, a new Ising model using n binary variables each of which is assigned to a respective one of n new subintervals that are obtained by further dividing the subinterval assigned to the binary variable whose value, which has been obtained as the execution result, is equal to the predetermined value,
further acquire values of the n binary variables which are an execution result of quantum annealing for the new Ising model, and
output, as a random number, a value included in the new subinterval assigned to the binary variable whose value, which has been obtained as the execution result of quantum annealing for the new Ising model, is equal to the predetermined value.

4. The random number generator according to claim 1, wherein a plurality of random numbers are output by acquiring execution results of quantum annealing processes that have been performed for the same Ising model a plurality of times.

5. The random number generator according to claim 1, wherein the processor is further configured to execute the instructions to:
generate s Ising models (s is an integer equal to or greater than 2), and
associate t binary variables (t is an integer equal to or greater than 4), which constitute a set of the binary variables in the s Ising models, with t qubits, respectively, of the same quantum annealing machine, and thereby acquires values of the t binary variables, which are execution results of quantum annealing processes for the s Ising models.

6. The random number generator according to claim 1, wherein the processor is further configured to execute the instructions to:
generate a pseudo-random number within the subinterval assigned to the binary variable whose value, which has been obtained as the execution result, is equal to the predetermined value, and
output the pseudo-random number within the subinterval selected according to the execution result.

7. The random number generator according to claim 1, wherein the processor is further configured to execute the instructions to receive an input for designating the subinterval.

8. A method for generating a random number, comprising:
receiving, by a random number generator, an input for designating a probability distribution of random numbers;
generating, by the random number generator and based on the probability distribution, an Ising model using n binary variables (n is an integer equal to or greater than 2) each of which is assigned to a respective one of n subintervals obtained by dividing a numerical range of random numbers;
acquiring, by the random number generator, values of the n binary variables, the values being an execution result of quantum annealing for the Ising model; and
outputting, by the random number generator and as a random number, a value included in the subinterval assigned to the binary variable whose value, which has been obtained as the execution result, is equal to a predetermined value.

9. A non-transitory computer readable medium storing a program for causing a computer to preform:
an input receiving step of receiving an input for designating a probability distribution of random numbers;
a model generation step of generating, based on the probability distribution, an Ising model using n binary variables (n is an integer equal to or greater than 2) each of which is assigned to a respective one of n subintervals obtained by dividing a numerical range of random numbers;
an annealing result acquisition step of acquiring values of the n binary variables, the values being an execution result of quantum annealing for the Ising model; and
a random number output step of outputting, as a random number, a value included in the subinterval assigned to the binary variable whose value, which has been obtained as the execution result, is equal to a predetermined value.
